(19) United States
(12) Patent Application Publication
(10) Pub. No.: US 2002/0036122 A1
(43) Pub. Date: Mar. 28, 2002

(54) Elevator communication system

(75) Inventors: Peter T. Fayette, San Diego, CA (US); Charles Jenkins, Sawanee, GA (US)

Correspondence Address: Mitchell P. Brook, Esq., BAKER & McKENZIE, 12th Floor, 101 West Broadway, San Diego, CA, 92101-3890, US

(73) Assignee: Televator Corporation

(21) Appl. No.: 10/001,287

(22) Filed: Oct. 31, 2001

Related U.S. Application Data
(63) Continuation-in-part of application No. 09/542,029, filed on Apr. 3, 2000.

(51) Int. Cl. B66B 1/28

(52) U.S. Cl. 187/391; 187/247

(57) ABSTRACT

The elevator communication system generally provides a computer device installed in an elevator cab. The computer device receives information content from several sources, including a networked server system. The server system communicates information to the computer device for presentation to passengers in the elevator. The computer device is also connected to an elevator controller so that the computer device can present information based on information received from the elevator controller.

This is a continuation-in-part of co-pending application Ser. No. 09/542,029, filed Apr. 3, 2000, entitled ELEVATOR COMMUNICATION SYSTEM, which is referred to and incorporated herein in its entirety by this reference.

### FIELD OF THE INVENTION

The field of the present invention is communications systems. More particularly, the field relates to a computer directed communication system configured for use in the cab of an elevator system.

### BACKGROUND OF THE INVENTION

Elevators are a ubiquitous aspect of modern life. Generally, elevators propel an elevator cab vertically to assist moving passengers and cargo between the floors of a multifloor building. In larger buildings, banks of elevators can be used to move people more efficiently. The typical elevator cab is constructed as a small box, with sliding doors that allow passengers to enter and exit. With the doors closed, the passenger or passengers are enclosed within the cab until the cab reaches a next destination floor. Although the typical elevator ride lasts only a short time period, many people find the ride uncomfortable. For some, a feeling of claustrophobia can turn the ride into a heart-racing panic. Such a response is not only uncomfortable for the person having the panic attack, but also can frighten or disturb any other passengers.

Even without claustrophobia, an elevator ride can be awkward. For example, the elevator ride may force total strangers to be in close bodily contact, a physical relationship that violates the normal personal spacing of some cultures. Although crammed closely together, the social norms in an elevator suggest that social discourse be avoided and everyone look forward. Thus a typical elevator ride may entail awkwardly watching the floor indicator lights, and anxiously waiting for the doors to open on a destination floor.

To make the elevator ride more comfortable, building managers may provide music into the elevator cab, or provide informational panels on the cab's walls. Such minor distractions, however, do not provide a sufficient focal point for the elevator passengers. The informational panels simply provide a static display such as printed advertising for a local restaurant or bar. As to the music feed, the popular perception is that music in an elevator is unsatisfactory. For example, “elevator music” is a phrase generally applied to dull, unappealing music.

When entering a building for the first time, it is often necessary to get directions from a directory board or a security guard. Building directory boards are often not current, and security personnel may be busy attending to other matters. Thus, finding your destination, or even what floor your destination is on, can be frustrating and time-consuming. Further, when exiting on a destination floor, it is often difficult to know which way to go. Not only can this waste time, but difficulty in finding the final destination is simply annoying and can be stressful.

Thus, there exists a need for enhancing the quality of an elevator ride. In such a manner, not only is there a need to make elevator riders more comfortable, but there is a need to present them with timely information.

### SUMMARY OF THE INVENTION

It is therefore an object of the present invention to enhance the quality of an elevator ride. It is a further object of the present invention to provide a focal point of information for an elevator rider. Therefore, to overcome the deficiencies in the known systems and to meet the identified objectives, an elevator communication system is disclosed. Briefly, the elevator communication system generally provides a computer device installed in an elevator cab. The computer device is configured with peripheral devices to display visual and audio information to cab riders. The computer device receives information content from several sources, including a networked server system. The server system communicates information to the computer device for presentation to passengers in the elevator. The computer device is also connected to an elevator controller so that the computer device can present information based on information received from the elevator controller. In one embodiment, the elevator communication system will queue and order received informational content based on data obtained from the elevator controller, thereby selecting which information is presented to elevator riders.

Advantageously, the elevator communication system eases the stress of riding an elevator by providing an active, prominent presentation of information. Not only is the presentation appealing and captivating, but the content is current and relevant so as to hold the attention of elevator riders. The elevator communication system provides useful information to the riders, thus saving the riders' time and creating a more efficient environment. Also, the elevator communication system can entertain the riders, or attract them to events or services. In this manner, the building manager can create revenue by selling advertising space or attracting additional patronage to a building service or event.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a perspective illustration of an elevator communication system made in accordance with the present invention;

FIG. 2 is a block diagram of an elevator communication system made in accordance with the present invention;

FIG. 3 is a block diagram of a computer device made in accordance with the present invention for use in an elevator cab;

FIG. 4 is a flowchart of a method of presenting information in an elevator cab in accordance with the present invention;

FIG. 5 is an example display for use with a computer device made in accordance with the present invention;

FIG. 6 illustrates example indicia for display in an elevator cab using an elevator communication system made in accordance with the present invention;

FIG. 7 illustrates an alternative example for exhibiting information in a display in an elevator cab using an elevation communication system made in accordance with the present invention; and

FIG. 8 illustrates an emergency information screen exhibited in a display in an elevator cab using an elevator communication system made in accordance with the present invention.

### DETAILED DESCRIPTION OF THE INVENTION

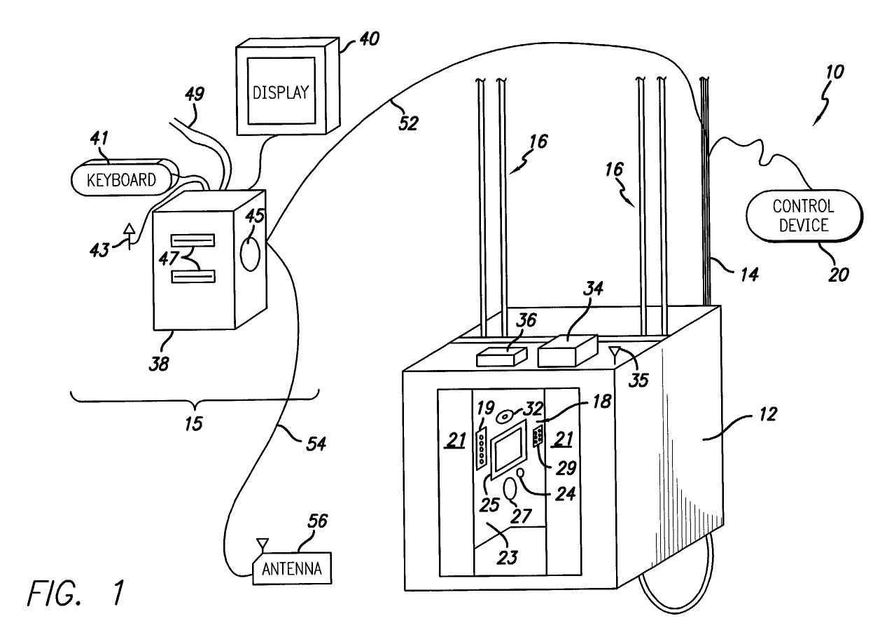

In accordance with the present invention, an elevator communication system is provided. Referring to FIG. 1, the elevator communication system 10 is illustrated installed on an elevator cab 12. The elevator cab 12 is generally an enclosed box having sliding doors 21 to provide access to the interior 18 of the cab 12. The cab 12 is propelled in a vertical shaft (not shown) by support cables 16. A wire bundle 14 is flexibly connected to the elevator cab 12 to provide electrical power and a communication link from the cab's elevator controls 19 to a remote elevator control device or elevator controller 20. Although the described example is shown using an elevator cab 12, or any such enclosed transportation is contemplated, such as trolley or train cabs, for example.

The elevator communication system 10 has a computer device, or cab computer 34 installed on the elevator cab 12. The computer device 34 is preferably constructed to be resistant to vibration and shock, so as to withstand the rigors of the elevator environment. Although the computer device 34 is shown mounted to the top surface of the cab 12, it will be appreciated that the computer device can be installed in alternative positions, such as inside the cab 12 or on the cab walls.

The computer device 34 is also preferably constructed from conveniently available off the shelf component parts, although it will be appreciated that more compact constructions can be made by custom fabricating application specific components. The computer device will generally have a main processing unit, such as an INTEL microprocessor (INTEL is a registered trademark of Intel Corp. of Santa Clara, Calif.), and associated support components such as memory and a backplane. The computer device 34 will also use an operating environment, such as MICROSOFT WINDOWS or UNIX (MICROSOFT WINDOWS is a registered trademark of Microsoft Corp. of Redmond, Wash., and UNIX is a registered trademark of AT&T of New York, N.Y.). The operating system not only operates the computer device 34, but also directs and controls the presentation of information in the cab 12. It will be appreciated that other processors, components, and operating systems can be substituted.

An uninterruptable power supply (UPS) 36 provides power to the computer device 34 and its peripherals during a power failure. Since a power failure can be a frightening situation in an elevator, it is important the elevator communication system 10 continue operation during any power outage.

The computer device 34 is connected to input and output peripheral devices in the cab's interior 18. For example, the computer device is connected to display 25, speaker 27, camera 32, keypad 29, and microphone 24. The computer device also communicates with the elevator controller 20, and the server system 15. It will be appreciate that other peripherals may be substituted depending on the specific information to be presented or collected in the elevator cab 12.

The display device 25 is preferably a flat LCD (liquid crystal display) panel, such as a TFT (thin film transistor) color display. Constructed as a flat panel device, the display device 25 is conveniently installed on or attached to a cab wall, such as cab wall 23. The display device 25 is configured to present full frame video at 30 frames per second. Such a speed enables a high quality, engaging visual display of information to elevator passengers. The display 25 can also display still images, text and animated information. It will be appreciated that the specific configuration of the display device can be modified for specific application needs.

The speaker 27 is mounted on the cab wall 23 near the display 25. The speaker may present the audio track for a video or graphic being presented, or can provide independent audio, such as an announcement or music. A microphone 24 is mounted adjacent the display 25 for accepting audio input from an elevator passenger. Accordingly, the microphone 24 and the speaker 27 cooperate to enable full-duplex voice communication. Such voice communication may be desirable in an emergency situation, or to instruct the computer device 34 with voice-activated commands, for example.

Also, a keypad 29 or keyboard is provided in the cab 12 for a passenger to input data into the computer device 34. For example, the user may request a map of a particular floor of a building, or want to see the menu from a building restaurant.

A camera 32 may also be mounted in the cab 12. The camera 32 may be used to facilitate live, full-duplex video conferencing with security personnel, for example. Also, the video camera 32 can provide a video feed for monitoring or taping by security personnel to increase security inside the elevator cab 12. With such a security monitoring presence, vandalism and unruly behavior may be reduced. Further, the data coming from the video camera 32 may be analyzed by the computer device 34 for adjusting the information being displayed to passengers. For example, if the video data suggests an adult entered the elevator with children from a hotel guest floor, the computer device 34 can select to run a video clip to advertise a premier restaurant available at the hotel, and immediately follow with an advertisement for the hotel's babysitting service, for example. Accordingly, the adult may not only use the hotel's babysitting service, but may also dine at one of the hotel's restaurant, thus increasing the hotel's revenues.

The computer device 34 receives much of its informational content from a server system 15 that communicates with elevator controller 20, and with distant information sources. The server system 15 is coupled to the computer device 34 by a communication link, such as data line 52. Data line 52 is a physical connection, such as a 10/100 mbit Ethernet connection, with the data line being incorporated in the wire bundle 14. If it is not possible to use a such a physical connection, the computer server can couple to a LAN antennae 56 through communication line 54. The LAN antennae 56 generates a wireless signal which can be received by cab antennae 35. The cab antennae 35 is connected to a transceiver device (not shown) for converting the wireless signal for use by the computer device 34. In a similar manner, wireless information can be sent from the elevator antennae 35 to the LAN antennae 56. It will be appreciated that various compression techniques can be used to reduce the data traffic on the communications links.

The server system 15 may be localized in the same building or the same campus area as the elevator. For example, the server system 15 may be incorporated with other building support equipment, such as security communication and control systems. Alternatively, the server system 15 may be located distant from the elevators 12. Indeed, the elevator communication system 10 enables a distant server system 15 to control the informational content displayed in many remote elevator cabs 12. Accordingly, a remotely operated content provider may provide and direct the informational content for several companies, buildings, or stores.

The server system 15 can be used to create and assemble informational content to be presented to cab passengers. Accordingly, the server system 15 has common peripheral devices such as a keyboard 41, microphone 43, speaker 45, and a display 40. The server system 15 also has drives 47 located in a computer server 38 for accessing information from CD ROMS or other magnetic media. The server system 15 also has a wide area connection 49, such as an Internet connection, for accessing information from other systems, or for receiving current information, such as stock quotes, for example. It will be appreciated that the server system 15 may be alternatively configured to create or receive other information depending on application specific needs.

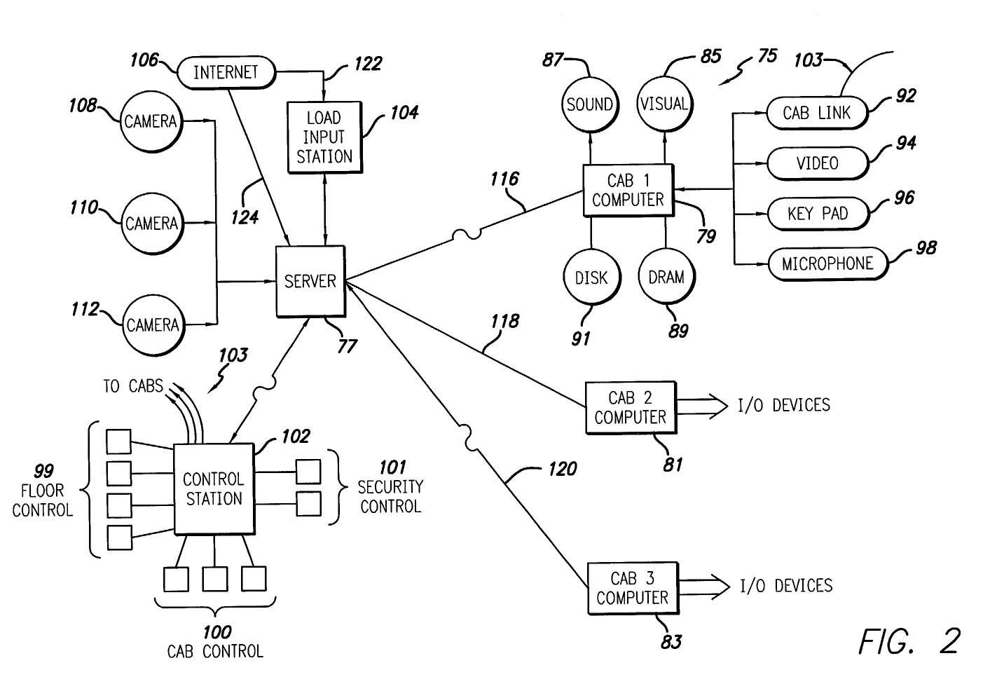

Referring now to FIG. 2, an elevator communication system 75 is shown. The elevator communication system 75 is similar to the elevator communication system 10 described above, except elevator communication system 75 illustrates a multiple cab elevator system. Accordingly, a first cab computer 79, a second cab computer 81, and a third cab computer 83 all couple to a server 77. The server 77 generates and compiles information to be presented in each of the elevator cabs 12. For example, the server 77 receives input from a local input station 104. The local input station 104 can be, for example, a networked computer device for passing daily conference information to the server 77. Further, an operator at the local input station 104 can access the Internet 106 via connection 122 to download information for presentation. The Internet 106 may also be directly connected to the server 77 for sending streaming data or real-time information for presentation in the cabs 12.

In another example, the operator may access the Internet to download video clips from a news organization and pass the video clip to the server 77. The server 77 will then communicate the video clip to all or selected cabs 12 for presentation. More specifically, the server 77 can send the video clip to computer 79 by Ethernet communication line 1, to computer 81 via RS232 line 118, or to computer 83 using wireless link 120. In each cab 12, the video clip is stored locally to optimize display performance and minimize communication line bottlenecks. For example, the video clip can be stored in disk 91. Further, video performance can be enhanced by buffering video data in a DRAM buffer memory 89. When activated by the cab's computer, the video clip can be presented to the passengers using a display and speaker, such as display 85 and speaker 87. Although only computer 79 is illustrated with specific peripherals, it will be appreciated that computer 81 and 83 have similar devices attached. For example, if the communication link from the server 77 to the cab computer 79 has sufficient bandwidth, video and graphical information can be presented without first storing the information on drive 91. Indeed, as the bandwidth is increased, a less powerful cab computer device may be used.

The server 77 is configured to not only send information retrieved and sent by a local input station 104, but the server 77 is also configured to receive and send live data directly from a wide area connection such as internet 106. For example, the server 77 may receive live news or stock information directly off the Internet, and send that information for display in any or all of the elevator cabs 12. Further, such display may be time sensitive. For example, financial news may be displayed in the early evening when business travelers are using the elevator cabs 12, but more general news would be displayed in the morning.

Cameras can also provide live video input into the system. For example, video camera 108 may be positioned at the security desk so that security personnel can direct his or her image into the cab 12. Such an image may assist in calming a passenger if an elevator cab 12 is stuck, or may provide the necessary “presence” to stop illegal or disturbing behavior by a passenger. Other video cameras, such as cameras 110 and 112, can be positioned so that each camera receives an image of a passageway outside the elevator cab 12 at each floor. In such a manner, a passenger in an elevator cab 12 can see who is outside the elevator cab 12 before exiting. If a camera is positioned in a parking garage area, for example, a passenger can verify that a safe exit path exists before leaving the relative safety of the elevator cab 12. Each of the cameras is preferably a CCD (charge couple device) generating digital video data, but it will be appreciated that other camera systems can be substituted. For example, an analog camera can be used, and the analog video signal converted to a digital signal for communication and storage purposes.

An elevator system also has floor controls 99 located at each floor, a cab control 100 in each cab, and security controls 101 for use by security or emergency personnel. These controls couple to a central elevator control station 102 that directs the travel of each elevator cab 12 via control lines 103. Accordingly, the elevator control station 102 is aware of cab specific information for each cab 12, such as the position of each cab 12, the status of the doors 21, direction of travel, and what floor is the next destination. Typically, the control station 102 or each cab link 103 can be accessed to retrieve some or all of the cab specific information. In one embodiment, the control station 102 is directly coupled to the server 77. In such a manner, the server 77 can use the cab specific information to specifically queue the information being presented in each cab 12. Alternatively, the cab computer, such as computer 103 with cab link 92, can intercept the cab specific data from a control line 103 or an elevator control unit on the cab. Cab link 92 can be, for example, an RS232 connection to cab control circuitry. Using this alternative, the cab computer receives the cab specific information and adjusts the presented information. It will be appreciated that other techniques can be used to capture cab specific information and adjust the presented information.

The computer device 34 is therefore constructed to make elevator-specific decisions on what information to display to elevator passengers. For example, cab specific information, such as current floor and next destination floor can be used to adjust information presented to cab 12 passengers. When stopped at a particular floor, directional information can be presented for that floor. When the doors close and the elevator is moving to the next destination floor, a map of the destination floor can be shown, along with audio descriptions, to facilitate navigating the destination floor. It will be appreciated that cab specific information can be used in a multitude of ways to adjust the information presented to cab passengers.

Cab computer 79 also has a video camera input 94, keypad 96, and microphone 98. Accordingly, a full duplex audio and video communication can be established between passengers in the elevator cab and security personnel, for example. Such a link would be advantageous in an emergency or stressful situation.

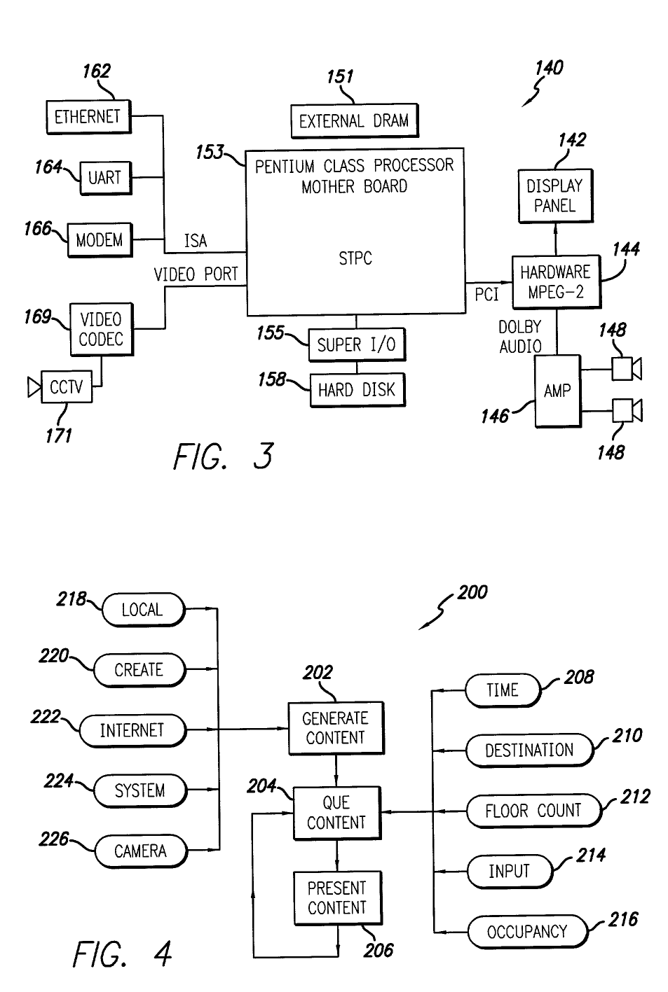

Referring now to FIG. 3, a specific example of a cab computer 140 is shown. The cab computer 140 is similar to cab computer 89 or 34 discussed above. Cab computer 140 has a main processor 153, DRAM 151 for buffering video data, and a fast I/O card communicating with a hard disk 158. A multimedia card 144 drives the display panel 142 and the speaker 148, which may be amplified by amplifier 146. An Ethernet connector 162, an RS232/422/485 port connector 164, and a modem connection are included in the processor 153, usually on the motherboard or as a card in a backplane. A high-speed digital video card 169 accepts video data from a video camera 171. Although a particular example of the cab computer is illustrated, it will be appreciated that other configurations and communication devices can be substituted.

FIG. 4 is a flowchart of a method constructed according to the present invention to generate, queue, and present information to passengers in an elevator cab 12. The general construct of the data flow is that informational content is generated as shown in block 202, the information is queued for presentation in block 204, and the informational content is presented or exhibited to cab passengers in block 206. Each of these general blocks is described in more detail below.

Block 202 shows generally that informational content is generated. This content can be derived from several sources, such as those shown as inputs to block 202. Local content 218, such as daily conference information or daily specials can be generated. Other local content could be real-time inputs such as local time or temperature. In another example, the hotel registration system could provide a local input. Accordingly, immediately after a guest for a particular convention checks in and enters his or her assigned floor into an elevator control, the elevator communication system can present convention information to that guest as the guest rides to his or her floor.

Content can also be created 220, such as floor maps or local advertisements. Information received from the Internet can facilitate creating such content. Further, the Internet 222 can directly provide content in the form of streaming data or live information feeds. The elevator system 224 can also generate data, such as emergency information, floor information, or security information. For example, the system can report that there is a security problem in the lobby, and direct the elevators to unload all passengers in a parking garage. In such a manner, the passengers could be fully informed and comfortable with the situation before arriving in the garage. Cameras 226, such as a camera for use by security personnel or a camera fixed at a destination floor, also provide content into the elevator communication system.

Once generated, the content must be queued for presentation. Some content can be defined as background content, which would remain queued and presented unless specifically directed by the elevator communication system 10. For example, a live Internet news feed can be the default content unless interrupted by more pressing content. In another example, text or still ads, as illustrated in FIG. 6 by indicia 279, can be the default presentation. The queuing of content may be done responsive to received selection data. Time 208, floor destination 210, floor count 212, passenger input 214, occupancy level 216, elevator cab 12 direction, a building movement indicating earthquake, and a fire alarm are examples of selection data for adjusting the queue of information content to be presented. It will be appreciated that other selection criteria may be used according to specific application needs.

Content may be adjusted by selection data in the form of time 208. For example, morning riders may be interested in the day's developing news, whereas evening riders may want to get a view and report on traffic conditions for the roadways. In another example, weekend patrons will have a different interest than weekday riders.

Also, the destination floor 210 can affect what content is queued. When a particular floor is selected as the destination floor, a directional sign, such as directional indicia 277 may be shown before arriving at the destination floor. Alternatively, a map, such as map indicia 281 can be queued. Even a directory of services or offices on the destination floor can be queued, as shown in indicia 283. Also, the queued content can be adjusted by what floors are not selected. For example, if an elevator cab's next destination passes by a particular floor in a multifloor retail outlet, the elevator can quickly queue up a reminder to passengers to stop on the yet unselected floor. In another scenario, different content can be queued depending on from which floor passengers entered the elevator. For example, if the elevator picks hotel guests up from the workout-room floor, then the elevator communication system may queue a video clip from the hotel's sports bar.

Also, an elevator rider may be able to generate selection data for the elevator communication system. A keypad 29, keyboard 41, mouse control, or even a voice-activated system can accept inputs from a rider. The user can request menus, directions, or security assistance, each of which will cause different information to be queued. Floor count, 212 can also affect queued information. If the elevator is scheduled to move only a few floors before stopping, only a short informational clip may be queued. However, if the elevator is scheduled for a longer run, then a longer segment can be displayed.

Selection data indicative of the occupancy 216 or number of people in the cab can also adjust the content. The number of people may be roughly calculated by floor stops and cab control inputs, by analysis of the video feed, or by sound level in the cab. For a larger group, a louder, and more visually stimulating presentation would more effectively hold the attention of the riders. Conversely, a single person or a small group may be more responsive to a more refined, softer message.

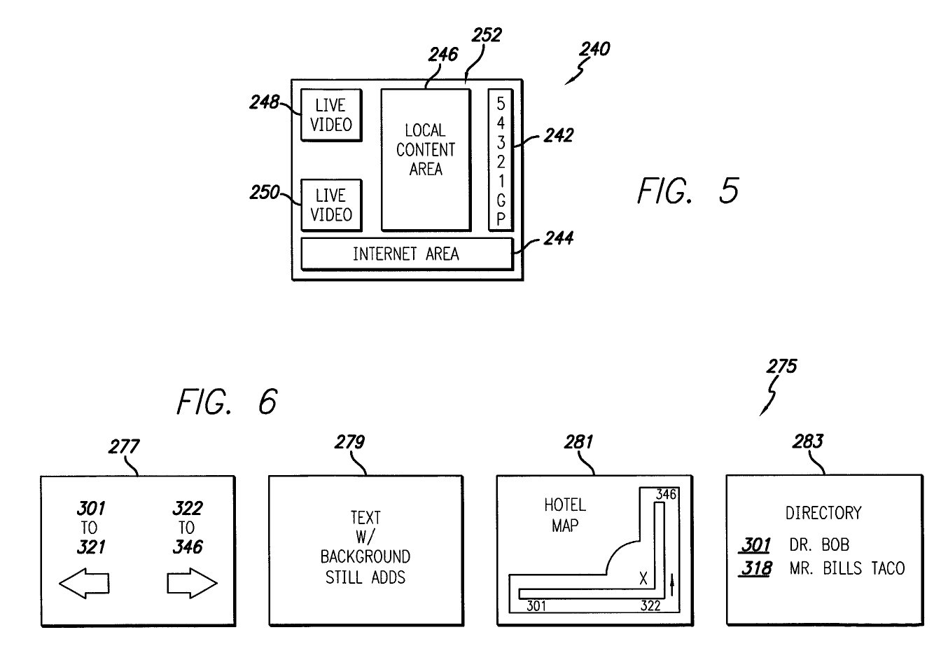

Once queued, the information is presented in block 206. The visual information can be presented in a display, such as the display 240 shown in FIG. 5. The display 240 has a display area 252 divided into particular display areas. For example, floor display 242 may show the next destination floor, including which floors will be stopped at to allow additional passengers into the cab. Live Internet area 244 may show live feed from a news organization, such as live stock quotes. The main local area 246 may show advertisements, floor maps, or directory information as described earlier. Live camera areas 248 and 250 may show live video from, for example, the area outside the next destination floors. Periodically, for example every 10 seconds, the elevator communication system 10 or 75 checks if new information is queued. If so, the new content is accessed and presented in the elevator cab. The display 300 exhibits information queued by the cab computer 34.

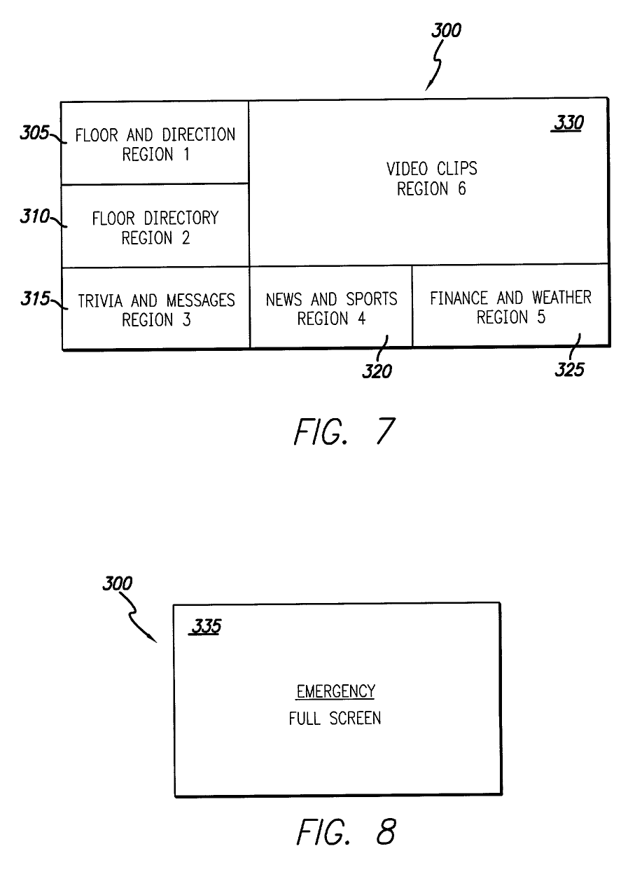

Referring now to FIG. 7, an alternative embodiment display 300 is illustrated. Preferably, the display 300 will be a 1024×768 pixel screen. Other pixel arrangements and screen configurations are also contemplated. The display 300 illustrated in FIG. 7 is segmented into six regions, comprising five smaller regions and one larger region. The five smaller regions include: floor and direction region 305; floor directory region 310; trivia and messages region 315; news and sports region 320; and finance and weather region 325. The larger region is the video region 330 and during emergencies such as fire, earthquake or other emergencies, an emergency region 335 illustrated in FIG. 8 would encompass substantially the entire display 300. One feature of the present invention is that the emergency region 335 can be activated when an emergency or a passenger entrapment occurs. The emergency region 335 can then exhibit an emergency screen that would contain messages such as: how to use the phone; instructing passengers to stay calm; instructing passengers to not pry the elevator doors 21 open; instructing passengers to move away from the elevator doors 21; and instructing passengers never to climb out of the elevator cab 12.

The floor and direction region 305 exhibits a current floor number, and a current elevator direction and comprises substantially 1/9 of the display 300 area. In one embodiment, the floor and direction region 305 would be 384×256 pixels. Other sizes and arrangements for the floor and direction region 305 are contemplated. Preferably, the server 38 will query the elevator controller or control device 20, forward the information to the cab computer 34, which will display the floor number and current elevator direction in the floor and direction region 305. The elevator communication system 10 is configured to communicate with any elevator controller 20 including controllers manufactured by Otis, O-Thompson, Kone, Mitsubishi, Thyssen-Krupp, and other manufacturers. The elevator communication system 10 obtains several informational components from the elevator controller 20. These components include, among others: the status of the elevator doors 21, open or closed; the position of each elevator cab 12 in the building; the direction of each elevator cab 12, whether ascending or descending; the elevator cab 12 calls input by passengers inside the elevator cab 12; the elevator 12 hall calls input by individuals located on a building floor; building movement information related to possible earthquakes; fire alarm information; and elevator cab 12 malfunction information.

Referring again to FIG. 7, the floor directory region 310 is configured to exhibit a listing of the offices and/or companies and/or people or other points of interest on the building floor at which the elevator cab will stop next. As illustrated in FIG. 7, in one embodiment the floor directory region 310 is located directly adjacent to the floor and direction region 305. In one embodiment the floor directory region 310 is the same size as the floor and direction region 305. During elevator operation, when the elevator doors 21 are closed, the floor directory region 310 will exhibit a new list for the next arrival floor when the elevator doors 21 are closed.

Positioned adjacent to the floor directory region 310 is the trivia and messages region 315. In one embodiment the trivia and messages region 315 is the same size as the floor directory region 310. The trivia and messages region 315 exhibits a trivia question followed by the trivia answer. In one embodiment, the trivia question and associated answer are randomly selected from a multiplicity of trivia questions and answers stored in the server 38. A preferred embodiment elevator communication system 10 will display the trivia question and associated answer for approximately 10 seconds and then proceed to exhibit a new trivia question and answer. Another embodiment of the elevator communication system 10 combines a message exhibited for approximately 10 seconds between the trivia question and trivia answer. The message will be obtained from a message list maintained in the server 15.

The news and sports region 320 is located adjacent to the trivia and message region 315. In one embodiment the news and sports region 320 is substantially the same size as the trivia and message region 315. The news and sports region 320 exhibits news or sports information, with each news and sports information item presented for approximately ten seconds. One method for exhibiting the news and sports information is to have the cab computer 34 access the server system 15 for a new news and/or sports information message. Alternatively the cab computer 34 may include one or more disks 47 that contain the news and sports information. Similarly, the trivia question and trivia answer and messages can be obtained from the server system 15 by the cab computer 34. In a preferred embodiment, the exhibited news and/or sports information item in the news and sports region 320 remain exhibited when the elevator doors 21 are open.

Located adjacent to the news and sports regions 320 is the finance and weather region 325. Preferably, the finance and weather region 325 is the same size as the news and sports region 320. In one embodiment of the elevator communication system 10 each of the above-identified smaller regions are the same size, approximately 320×288 pixels. The finance and weather region exhibits finance and/or weather information for approximately ten seconds and then displays a new finance and/or weather message. The new finance and/or weather message is obtained from the server system 15 by the cab computer 34. In a preferred embodiment, the finance and weather region 325 exhibits messages when the elevator doors 21 are open.

The largest region on the display 300 is the video region 330. The video region is approximately 640×480 pixels or approximately 4/9nths of the total display 300 area. The video region 330 displays one video at a time and the order in which videos are played is supplied from a queue located either on the cab computer 34 or on the server system 15.

In one embodiment of the present invention, the server 38 will store the videos and present them in a prioritized schedule list comprising: building floor videos; time of day videos; common videos; public service videos in a ratio with common videos and emergency videos when necessary. Common videos comprise videos that are not emergency or public service videos.

In one embodiment, the server 34 will store each type of video clip in a separate bin that can be updated with new videos from video content providers or from other sources. One example of a video priority play list that could be generated when an elevator cab 12 is located on a first building floor and called to a second and eighth building floor would be the following: server system 15 downloads to computer device 34 a building floor video, then a building time video, then a common video until the estimated time for the elevator cab 12 to move from floor 1 to floor 8 is full. The elevator cab 12 movement from building floor 1 to building floor 2 is one floor movement and a building floor 2 video would be displayed. Between building floor 2 and building floor 8 there are six floor movements so six videos would be displayed in the order of: a building floor 8 video, a time of day video, a common video, another building floor 8 video, another time of day video, and a final common video. Another feature of the present invention is that the server system 15 maintains data on the number of videos that have been exhibited in each computer cab 12. In this way, advertisers can be billed and appraised of the number of times that their videos have been exhibited.

When the elevator doors are opened, the video playing in the video region 330 will continue to run until the video is completed. One advantage of the present invention is that videos are not exhibited in the video region 330 when the elevator is dormant or unoccupied. For example, the cab computer 34 queries the elevator controller 20 to determine the status of the elevator cab 12. If an occupant boards the elevator cab 12 and inputs a command to the elevator control 19 indicating a lengthy elevator ride, the cab computer 34 obtains this information from the elevator controller 20 and queues a longer video for display in the video region 330. In this manner, the length of the video can be tailored to the length of the elevator cab 12 ride. Alternatively, the video presented in the video region 330 can be changed to reflect the building destination floor. For example, if a restaurant is located on a specific building floor, the cab computer 34 will access the elevator controller 20, determine that the elevator cab 12 has been instructed to stop at the restaurant floor, the cab computer 34 will exhibit a restaurant video in the video region 330.

The disclosed elevator communications system is useful for creating a safer and more pleasant experience for elevator riders. Not only is the aesthetics of the ride improved, but the system is also able to entertain and provide important information to the riders. Further, the elevator communications system provides additional revenue possibilities through the sale of advertising and the attraction of additional patronage to building services and attractions.

One skilled in the art will appreciate that the present invention can be practiced by other than the preferred embodiments which are presented in this description for purposes of illustration and not of limitation, and the present invention is limited only by the claims which follow. It is noted that equivalents for the particular embodiments discussed in this description may practice the invention as well.

What is claimed is:

1. An elevator communication system, comprising:
a cab computer coupled to an elevator cab and communicating with an elevator control system and a server, the server containing information content;
a display communicating with the cab computer, the display positioned inside the elevator cab;
wherein the cab computer performs the steps of:
receiving data from the elevator control system;
choosing specific information content based on the data received from the elevator control system; and
presenting the chosen information content on the display.

2. The elevator communication system of claim 1, wherein the data received from the elevator control system is selected from the group consisting of: a time of day; an elevator door position; an elevator location; an elevator direction; a building floor arrival order; a building movement; and a fire alarm.

3. The elevator communication system of claim 1, wherein the cab computer determines an elevator ride duration from the data received from the elevator control system.

4. The elevator communication system of claim 1, wherein the display comprises a plurality of regions, the regions selected from the group consisting of: a floor and direction region; a floor directory region; a trivia region; a message region; a trivia and message region; a news region; a sports region; a news and sports region; a finance region; a weather region; a finance and weather region; a video region; and an emergency region.

5. The elevator communication system of claim 4, wherein the floor and direction region exhibits a current floor number, a current elevator direction and comprises substantially one-ninth of a display area.

6. The elevator communication system of claim 4, wherein the floor directory region exhibits a list, the list selected from at least the group consisting of: an office, a company, an individual, and other items of interest located on a building floor at which the elevator will stop next.

7. The elevator communication system of claim 6, wherein the floor directory list changes to the next arrival floor when an elevator door is closed, and comprises substantially one-ninth of a display area.

8. The elevator communication system of claim 4, wherein the trivia region exhibits a question followed by an associated answer, the question and associated answer randomly selected from a multiplicity of questions and associated answers stored in the server.

9. The elevator communication system of claim 8, wherein the trivia region comprises substantially one-ninth of a display area, and exhibits the question and the associated answer for approximately 10 seconds.

10. The elevator communication system of claim 4, wherein the message region exhibits a message for approximately 10 seconds, the message randomly selected from a multiplicity of messages stored in the server, and the message region comprises substantially one-ninth of a display area.

11. The elevator communication system of claim 4, wherein the trivia and message region selectively exhibits a question followed by an associated answer or a message, each message, question and associated answer presented for approximately 10 seconds.

12. The elevator communication system of claim 4, wherein the news region exhibits news for approximately 10 seconds, the news randomly selected from a multiplicity of news items stored in the server, and the news region comprises substantially one-ninth of a display area.

13. The elevator communication system of claim 4, wherein the sports region exhibits sports information for approximately 10 seconds, the sports information randomly selected from a multiplicity of sports information items stored in the server, and the sports region comprises substantially one-ninth of a display area.

14. The elevator communication system of claim 4, wherein the news and sports region selectively exhibits news or sports information, with each news and sports information item presented for approximately 10 seconds.

15. The elevator communication system of claim 14, wherein the selectively exhibited news and sports information items remain displayed when an elevator door is open.

16. The elevator communication system of claim 4, wherein the finance region exhibits finance information for approximately 10 seconds, the finance information randomly selected from a multiplicity of finance information items stored in the server, and the finance region comprises substantially one-ninth of a display area.

17. The elevator communication system of claim 4, wherein the weather region exhibits weather information for approximately 10 seconds, the weather information randomly selected from a multiplicity of weather information items stored in the server, and the weather region comprises substantially one-ninth of a display area.

18. The elevator communication system of claim 4, wherein the finance and weather region selectively exhibits finance and weather information, with each finance and weather information item presented for approximately 10 seconds.

19. The elevator communication system of claim 18, wherein the weather and finance region selectively presents weather and finance information while an elevator door remains open.

20. The elevator communication system of claim 4, wherein the video region exhibits videos selected from the group consisting of: time of day videos; building floor videos; emergency videos; public service videos; and common videos.

21. The elevator communication system of claim 20, wherein the videos are exhibited in a sequence consisting of: building floor videos, time of day videos, common videos, and a ratio of public service videos.

22. The elevator communication system of claim 20, wherein the server generates a list of each video exhibited in the elevator cab.

23. The elevator communication system of claim 20, wherein the video exhibited in the video region plays to completion when an elevator door is opened.

24. The elevator communication system of claim 20, wherein the video display is dormant when the elevator is inactive.

25. The elevator communication system of claim 4, wherein the emergency region exhibits specific emergency information when an emergency occurs, and the emergency region comprises substantially an entire display area.

26. The elevator communication system of claim 4, wherein the display comprises:
a floor and direction region located a first corner of the display;
a trivia region located in a second corner of the display;
a floor directory region located substantially between the floor and direction region and the trivia region;
a finance and weather region located in a third corner of the display;
a news and sports region located substantially between the trivia region and the finance and weather region; and
a video region located in a fourth corner of the display.

27. The elevator communication system of claim 1, wherein the display is inactive when the elevator is dormant.

28. The elevator communication system of claim 1, further including an audio speaker communicating with the cab computer and positioned inside the elevator cab.

29. The elevator communication system of claim 1, further including a keypad in the elevator cab, and wherein the keypad is used to present specific information content.

30. The elevator communication system according to claim 1, further including a microphone in the elevator cab, and wherein a voice command received from the microphone is used to selectively present specific information content and communicate with individuals outside the elevator.

31. The elevator communication system according to claim 1, further including a video camera in the cab generating video data, and wherein the video data is used to by the cab computer to select and present specific information content.

32. The elevator communication system according to claim 1, further including a video camera in the cab generating video data, wherein the video data is communicated to a display at a security console.

33. The elevator communication system according to claim 1, further including an Internet communication line coupled to the server, wherein the server routes Internet content received from the Internet to the cab computer.

34. The elevator communication system according to claim 1, further including an antennae connected to the server and a cab antennae connected to the cab computer, wherein a wireless communication link is established between the server and the cab computer.

35. The elevator communications system according to claim 1 further including a camera mounted remote from the cab and directed toward a passageway near an exit to the elevator cab, the camera being coupled to the server.

36. The elevator communications system according to claim 1 further including a camera mounted remote from the cab and directed toward a security person, the camera being coupled to the server, so that the security person can be exhibited on the display.

37. A method of presenting information content in an elevator cab located in a building, the method comprising the steps of:
generating at least a portion of the information content at a location physically remote from the building;
sending at least a portion of the information content to an apparatus located in the building;
relaying data from an elevator control system to the apparatus;
queuing, responsive to the data relayed from the elevator control system, portions of the information content; and
forwarding the queued information content to the elevator cab.

38. The method of presenting information content of claim 37, wherein the step of queuing, responsive to the data relayed from the elevator control system, portions of the information content comprises any one of the steps selected from the group consisting of:
determining a time of day; determining an elevator ride duration from the data received from the elevator control system; determining an elevator location; determining an elevator direction; determining a building floor arrival order; determining a building movement; and detecting a fire alarm.

39. The method of presenting information content of claim 37, wherein the building includes a plurality of elevator cabs, and the method further includes the steps of:
relaying data from an elevator control system to the apparatus, the data including facts from each of the elevator cabs;
queuing, in response to the facts from each of the elevator cabs, specific information content tailored to each of the elevator cabs; and
forwarding the queued informational content to each of the elevator cabs.
